(19) United States
(12) Patent Application Publication
(10) Pub. No.: US 2019/0327986 A1
(43) Pub. Date: Oct. 31, 2019

(54) A VEGETABLE BOX CAPABLE OF PRESERVING THE PRODUCTS IN A FRESH STATE FOR AN EXTENDED PERIOD OF TIME BY EXCHANGING THE AIR COMPOSITION IN THE BOX

(71) Applicant: TUBITAK, Ankara (TR)

(72) Inventors: Ibrahim Sani ÖZDEMIR, Kocaeli (TR); Hatice AKSOY, Kocaeli (TR)

(73) Assignee: TUBITAK, Ankara (TR)

(21) Appl. No.: 16/474,053

(22) PCT Filed: Dec. 21, 2017
(86) PCT No.: PCT/IB2017/058278

§ 371 Date: Jun. 26, 2019

(30) Foreign Application Priority Data
Dec. 28, 2016 (TR) TR2016/19950

(51) Int. Cl. A23B 7/015; A23B 7/148

(52) U.S. Cl. CPC A23B 7/015; A23V 2002/00; A23B 7/148

(57) ABSTRACT

The invention relates to a vegetable box which is capable of preserving the products in the box in a fresh state and for an extended period of time by exchanging the air composition inside the box via the respiration and photosynthesis of the fresh fruits/vegetables, and thus ensuring the oxygen and/or carbon dioxide to reach the target partial pressure and stabilizing the same at these values. The invention is characterized by comprising a lock sensor (6) which is arranged in the internal portion of the body (1) at the section where the body (1) contacts with the cover (2) and which senses the opening/closing of the cover (2); a gas sensor (7) which is disposed inside the body (1) and which measures the partial pressure of the oxygen and/or carbon dioxide gases inside said body (1), and then informs the control unit (9) of the obtained pressure values; and an electronic control unit (9) which, using the information from the lock sensor (1) and gas sensor (7), activates/deactivates the lighting unit (8) and which is disposed in the body (1).

### TECHNICAL FIELD OF THE INVENTION

The present invention relates to a vegetable box which is capable of preserving the products therein in a fresh state and for an extended period of time.

The invention more particularly relates to a vegetable box which is capable of preserving the products therein in a fresh state and for an extended period of time by ensuring that oxygen and/or carbon dioxide reaches target partial pressure value via alternatingly triggering two counteracting physiological reactions naturally taking place in plant cells, namely, respiration and photosynthesis, for modifying and maintaining the optimum atmospheric composition in an airtight vegetable box.

### PRIOR ART

Vegetable storage units are products that are used for storing vegetables and/or fruits and the like in such places as kitchens, balconies, or cellars. However, the stored products may lose freshness, even decompose in time.

A vegetable box that is capable of preserving vegetables-fruits in a fresh state has been needed in order to overcome such undesired issues.

U.S. Patent Application Numbered US2011297241 filed on 15 Aug. 2011 within the state of the art discloses a modular appliance which supplies a modified atmosphere in the food retaining enclosed space by injecting a suitable gas mixture into the food retaining enclosed space by means of an external unit in order to elongate the shelf life of products.

U.S. Patent Application Numbered US2002033023 filed on 11 Sep. 2001 within the state of the art discloses a refrigerator crisper drawer which reduces the partial pressure of the oxygen in the air within the crisper by means of a nitrogen concentrator disposed in the crisper drawer, thereby preventing the vegetables from oxidizing, i.e. from “browning”.

The U.S. Patent Application Numbered US2014017988 filed on 1 Dec. 2012 within the state of the art, on the other hand, discloses a nitrogen generator unit disposed outside the storage device for the modification of the internal environment of the vegetable drawer and a system which comprises a carbon dioxide gas retaining tablet disposed in the storage device.

Nevertheless, the application of these patent documents is limited in practical terms. It is because such applications are based on partially or wholly removing the oxygen in the air within the crisper. In this case, it is highly likely that all of the existing oxygen will be consumed by the products respiring inside the crisper and that anaerobic respiration occurs inside the crisper, as a result of which the products are decomposed. Yet, none of the patent documents cited above has provided a solution regarding the supply of the oxygen consumed during the respiration of the products inside the crisper, into the crisper. Further, all of the aforementioned systems require the use of additional equipment for exchanging the air composition inside the crisper, for example gas generator, gas flushing unit or vacuum pump.

The Chinese Patent Application Numbered CN205106210U filed on 15 Oct. 2015 within the state of the art discloses a device having a LED lighting system and in which vegetables-fruits are stored. This device consists of LED lights capable of lighting at ultraviolet and visible light wavelength, a temperature and moisture control unit, a fan and a ventilator. In this invention, the wavelength of LED lights can be adjusted according to the vegetable placed therein. With this device, the products can be stored at optimal temperature and moisture, as well as photosynthesizing.

Another Chinese Patent Application in the state of the art is the Patent Numbered CN201444866U filed on 3 Jul. 2009; wherein a photosynthetic fresh-keeping box used in refrigerators is disclosed. This fresh-keeping box provides the products with photosynthetic energy by means of the LED light comprised thereby.

However, none of these patent documents utilizes photosynthesis in order to create a suitable atmosphere composition elongating the shelf lives of the products inside the crisper.

The fact that there exists no vegetable box which enables the products to photosynthesize or respire according to the partial pressure of the oxygen and/or carbon dioxide inside the box, and thus stabilizes the partial pressure of the oxygen and carbon dioxide of the air inside the box at target values and which is capable of preserving, i.e. storing, the products in a fresh state and for an extended period of time has deemed it necessary to develop the vegetable box according to the invention.

### OBJECTS AND SUMMARY OF THE INVENTION

The object of the present invention is to provide a vegetable box which is capable of preserving the products for a longer period of time and in a fresh state.

Another object of the invention is to provide a vegetable box which ensures that the products therein remain fresh for an extended period of time by modifying and maintaining the atmosphere at a desired composition inside the box.

Still another object of the invention is to provide a vegetable box which makes measurements as to whether the partial pressure of the oxygen and/or carbon dioxide inside the vegetable box is at the desired values; which, according to the result of the measurement, enables the products to photosynthesize or respire; and which thus stabilizes the air composition at desired values and hence is capable of preserving products fresh for an extended period of time.

Another object of the invention is to provide a vegetable box which provides the products with the required energy in order that they will photosynthesize, by means of the lighting unit that it comprises.

The partial pressure value of the oxygen or carbon dioxide in the box is measured by means of the gas sensor comprised by the vegetable box. In case the oxygen partial pressure in the box is 0.5 kPa less than the target oxygen value, the gas sensor informs the control unit of it, and the lighting unit is activated by the control unit. Thus, the required light energy for the photosynthesis of the products is provided and the products start to photosynthesize; producing oxygen, consuming carbon dioxide. In case the oxygen partial pressure inside the box is 0.5 kPa more than the target oxygen value, on the other hand, the gas sensor informs the control unit of it, and the lighting unit is deactivated by the control unit. As a result, the products start to respire normally, i.e. they consume oxygen and produce carbon dioxide. By continuing with this process cycle, the air composition inside the vegetable box is stabilized at the target air composition value that will preserve the freshness of the products for an extended period of time. The lock sensor senses whether the cover is open or close and informs the control unit of it. When the cover is open, no unit inside the box operates.

### DETAILED DESCRIPTION OF THE INVENTION

The vegetable box which is capable of preserving the products in a fresh state for an extended period of time by modifying and maintaining the atmosphere at a desired composition inside the box is illustrated in the drawings.

In which;

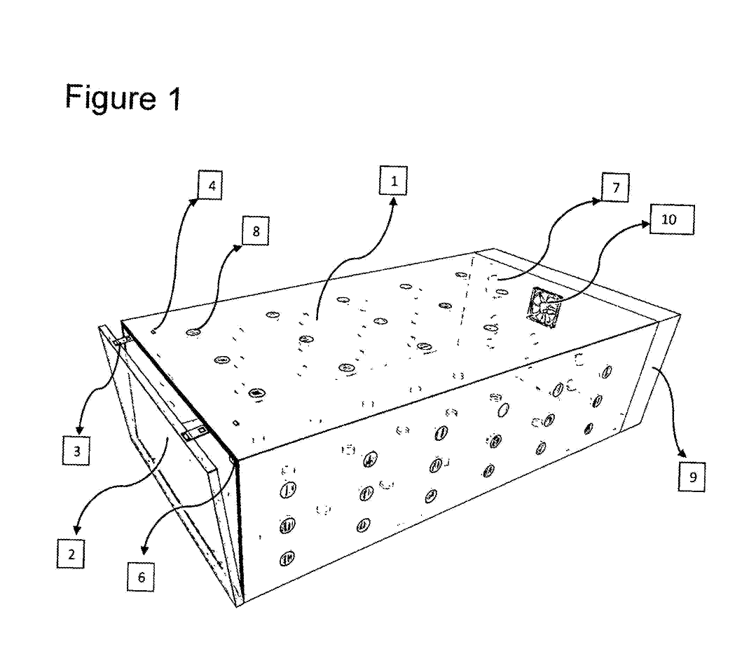

FIG. 1 is the schematic view of the vegetable box according to the invention.

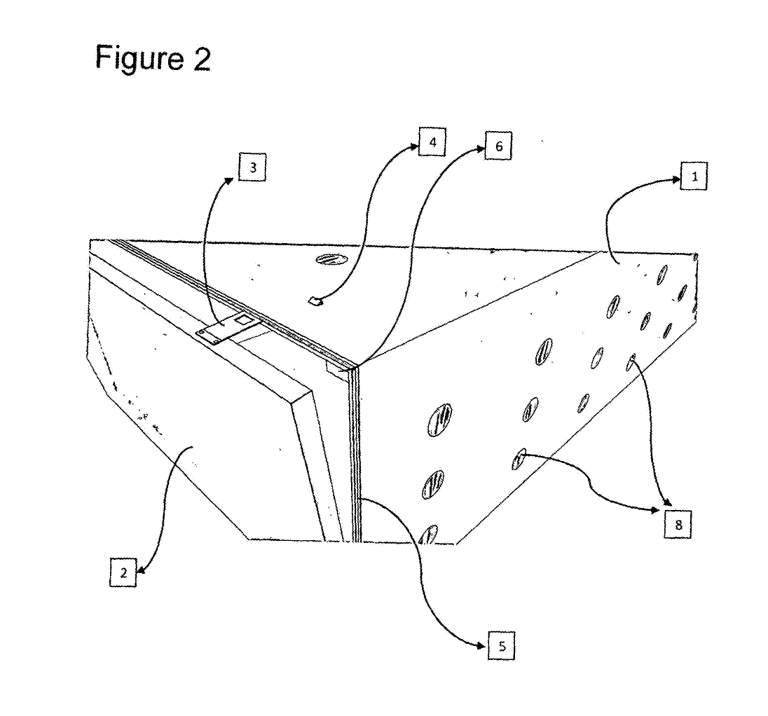

FIG. 2 is the partial schematic view of the vegetable box according to the invention from a different angle.

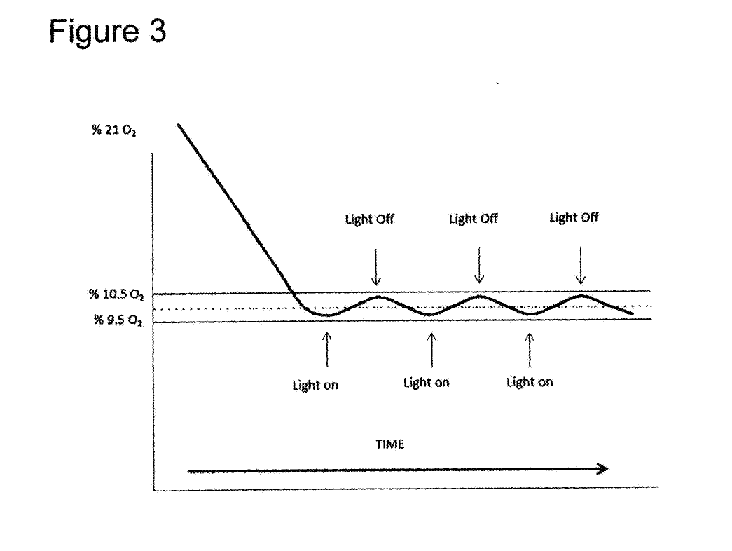

FIG. 3 is the graphical representation of the operating cycle of the vegetable box according to the invention.

The parts shown in the drawings are enumerated individually and the corresponding reference numerals thereto are given below.
1. Body
2. Cover
3. Lock hinge
4. Punch
5. rubber gasket
6. Lock sensor
7. Gas sensor
8. Lighting unit
9. Control unit
10. Fan

The vegetable box according to the invention comprises:
a cover (2) which can be tightly closed by means of the lock hinge (3) disposed thereon and the punches (4) present on the body (1) corresponding to the lock hinge (3),
a lock sensor (6) which is arranged in the internal portion of the body (1) at the section where the body (1) contacts with the cover (2) and which senses the opening/closing of the cover (2),
a gas sensor (7) which is disposed inside the body (1) and which measures the partial pressure values of the oxygen and/or carbon dioxide particles inside said body (1), and then informs the control unit (9) of the obtained pressure values,
a lighting unit (8) mounted in at least one wall of the body (1) and providing the products with the required energy in order that they will photosynthesize, and
an electronic control unit (9) which, using the information from the lock sensor (6) and gas sensor (7), activates/deactivates the lighting unit (8).

The vegetable box according to the invention comprises a rubber gasket (5) in the body (1) at the section where the body (1) is coupled to the cover (2).

The vegetable box according to the invention comprises a fan (10) which is operated by the information from the electronic control unit (9) and allows a homogeneous distribution of the air in the body (1), said fan being mounted in the body (1).

Once the vegetables and/or fruits are laced in the vegetable box, the cover (2) is closed tightly by means of the at least one lock hinge (3) disposed on the cover (2) and the punches (4) corresponding thereto. A rubber gasket (5) is provided at the section where the cover (2) is coupled to the body (1) such that the air tightness will be ensured when the cover (2) is closed. Disposed at the section where the body (1) contacts with the cover (2) is the lock sensor (6). This lock sensor (6) communicates with the electronic control unit (9) upon the opening of the cover (2) and informs it of the opening/closing of the cover (2).

Also provided is a gas sensor (7) that senses the partial pressure of the oxygen and/or carbon dioxide gases inside the vegetable box. The gas sensor (7) informs the control unit (9) when the partial pressure of the environment oxygen gas is 0.5 kPa less than the target value. The control unit (9) communicates with a plurality of lighting units (8) using lights having 300-700 nm wavelength such as LEDs-OLEDs scattered on the side walls of the body (1) and the body (1) is illuminated. Thus, the required energy for the fruit and/or vegetables inside the body (1) to photosynthesize is supplied.

During such photosynthesis, the amount of oxygen in the environment increases while the amount of carbon dioxide decreases. The gas sensor (7) communicates with the electronic control unit (9) when the partial pressure of the oxygen gas inside the body (1) is 0.5 kPa more than the target value and the control unit (9) informs the lighting units (8) of it, thereby deactivating them. As a consequence, the required energy for the photosynthesis of the fruit and/or vegetables is interrupted and they start to respire normally.

In case the gas sensor (7) is a carbon dioxide, the operating principle of the vegetable box will be as follows: the amount of oxygen in the environment decreases while the amount of carbon dioxide increases during the respiration of the fruits and/or vegetables. The gas sensor (7) communicates with the electronic control unit (9) when the pressure of the carbon dioxide gas inside the body (1) is 0.5 kPa more than the target value and the control unit (9) informs the lighting units (8) of it, thereby activating said lighting units (8). Thus, the required energy for the products inside the body (1) to photosynthesize is supplied. Afterwards, the partial pressure of the carbon dioxide inside the vegetable box decreases depending on photosynthesis. The gas sensor (7) communicates with the electronic control unit (9) when the decrease in the partial pressure of the carbon dioxide is 0.5 kPa lower than the target value and the control unit (9) informs the lighting units (8) of it, thereby deactivating them. As a consequence, the required energy for the photosynthesis of the fruit and/or vegetables is interrupted and they start to respire normally. Thus, the air composition inside the body (1) is constantly stabilized at the desired target values.

This cycle continuously occurs as long as the cover (2) is closed, depending on the partial pressure of the oxygen or carbon dioxide gases. At the same time, a fan (10) is present in the body (1). This fan (10) is operated by the information from the electronic control unit (9) and allows a homogeneous distribution of the air in the body (1) prior to the measurement of the gas sensor (7).

With the present invention, the products in the vegetable box preserve their freshness for an extended period of time without requiring the use of additional equipment such as gas generator, gas flushing unit or vacuum pump.

1. An air tight vegetable box comprising:
a lighting unit (8) mounted in at least one wall of the body (1) and providing the products with the required energy in order that they will photosynthesize, characterized in that it further comprises:
a gas sensor (7) which is disposed inside the body (1) and which measures the partial pressure of the oxygen and/or carbon dioxide gases inside said body (1), and then informs the control unit (9) of the obtained pressure values, and
an electronic control unit (9) which, using the information from the lock sensor (6) and gas sensor (7), activates/deactivates the lighting unit (8) and which is disposed in the body (1).

2. A vegetable box according to claim 1, characterized in that it comprises an air tight cover (2) which can be tightly closed by means of the lock hinge (3) disposed thereon and the punches (4) present on the body (1) corresponding to the lock hinge (3).

3. A vegetable box according to claim 2, characterized in that it comprises a lock sensor (6) which is arranged in the internal portion of the body (1) at the section where the body (1) contacts with the cover (2) and which senses the opening/closing of the cover (2).

4. A vegetable box according to claim 2, characterized that it comprises a rubber gasket (5) in the body (1) at the section where the body (1) is coupled to the cover (2).

5. A vegetable box according to claim 1, characterized that it comprises a fan (10) which is operated by the information from the electronic control unit (9) and allows a homogeneous distribution of the air in the body (1), said fan being mounted in the body (1).

6. A vegetable box according to claim 1, characterized in that the body (1) is made of a metal, plastic, or a glass material, the oxygen and carbon dioxide permeability amount of which is lower than 100 cm³/m²/day.

7. A vegetable box according to claim 1, characterized in that it comprises a lighting unit (8) using LED lights having 300-700 nm wavelength and scattered on the walls of the body (1).

8. A vegetable box according to claim 1, characterized in that it comprises a lighting unit (8) using OLED lights having 300-700 nm wavelength and scattered on the walls of the body (1).

9. A vegetable box according to claim 1, characterized in that it can be used in any kind of cooling appliance.
